(19) United States
(12) Patent Application Publication
(10) Pub. No.: US 2024/0096195 A1
(43) Pub. Date: Mar. 21, 2024

(54) NOTIFICATION SYSTEM, NOTIFICATION METHOD, AND NON-TRANSITORY STORAGE MEDIUM

(71) Applicant: NEC Corporation, Minbo-ku, Tokyo (JP)

(72) Inventors: Takahiro YAMADA, Tokyo (JP); Naomi YAMASHITA, Tokyo (JP)

(73) Assignee: NEC Corporation, Minbo-ku, Tokyo (JP)

(21) Appl. No.: 18/038,318

(22) PCT Filed: Oct. 19, 2021
(86) PCT No.: PCT/JP2021/038546

§ 371 Date: May 23, 2023

(30) Foreign Application Priority Data
Nov. 27, 2020 (JP) 2020-196691

(51) Int. Cl. G08B 21/22; G06T 7/70

(52) U.S. Cl. CPC G08B 21/22; G06T 7/70; G06T 2207/30242

(57) ABSTRACT

The present invention provides a notification system (10) including: a customer status information generation unit (11) generating, based on an image in which the inside of a store is captured, customer status information indicating at least one of the number of customers waiting for checkout and the number of customers in the store; a checkout work region information generation unit (12) generating, based on an image in which the inside of the store is captured, checkout work region information indicating status of a checkout work region where a clerk performing checkout work is positioned; a determination unit (13) determining, based on the customer status information and the checkout work region information, whether to make notification of an assistance request for checkout work; and a notification unit (14) making notification of the assistance request through an output apparatus when notification of the assistance request is determined to be made.

### TECHNICAL FIELD

The present invention relates to a notification system, a notification method, and a program.

### BACKGROUND ART

Patent Document 1 discloses a technology related to the present invention. Patent Document 1 discloses an apparatus detecting a state of a clerk existing in a store, based on an image in which the inside of the store is captured, and making notification of an instruction to operate a register apparatus, based on the detection result. More specifically, Patent Document 1 discloses making the aforementioned notification when a clerk staying in a region outside a checkout work region and performing work different from checkout work is detected based on an image in which the region outside the checkout work region in the store is captured.

### Related Document

### Patent Document

Patent Document 1: Japanese Patent Application Publication No. 2015-149089

### DISCLOSURE OF THE INVENTION

### Technical Problem

Some customers feel waiting for checkout to be stressful. By reducing waiting time for checkout, customer satisfaction is improved, and sales increase at a store, and the like can be expected. For example, use of a technology detecting, by image analysis or the like, the necessity of increase in the number of clerks performing checkout work and notifying a clerk of the necessity enables prompt increase in the number of clerks performing checkout work at a necessary timing and reduction in customer waiting time.

However, reduction of unnecessary notifications by making notification at a truly necessary timing is required in such a notification technology. There is an issue that excessive unnecessary notifications cause a recipient (clerk) of a notification to feel the notification annoying or neglect the notification. Patent Document 1 discloses a technology of analyzing a video in which “a region outside a checkout work region” in a store is captured and determining the necessity of notification, based on the result, in order to reduce unnecessary notifications. The technology in Patent Document 1 has an issue as follows.

The aforementioned region outside a checkout work region is a region including a region where products are displayed, a backyard, and the like, and the area of the region is relatively large. In such a case that a region to be surveilled is wide, issues such as “a burden of costs increases due to a large number of pieces of installed equipment (such as a camera),” “a burden of costs and a burden of labors required for maintenance of installed equipment increases,” and “a burden of processing by a computer increases due to an enormous amount of generated image data” may occur.

An object of the present invention is to detect the necessity of increase in the number of clerks performing checkout work and reduce unnecessary notifications.

### Solution to Problem

The present invention provides a notification system including:

a customer status information generation unit that, based on an image in which an inside of a store is captured, generates customer status information indicating at least one of a number of one or more customers waiting for checkout and a number of one or more customers in a store;

a checkout work region information generation unit that, based on an image in which an inside of a store is captured, generates checkout work region information indicating status of a checkout work region where a clerk performing checkout work is positioned;

a determination unit that, based on the customer status information and the checkout work region information, determines whether to make notification of an assistance request for checkout work; and

a notification unit that makes notification of the assistance request through an output apparatus when notification of the assistance request is determined to be made.

Further, the present invention provides a notification method including, by a computer:

based on an image in which an inside of a store is captured, generating customer status information indicating at least one of a number of one or more customers waiting for checkout and a number of one or more customers in a store;

based on an image in which an inside of a store is captured, generating checkout work region information indicating status of a checkout work region where a clerk performing checkout work is positioned;

based on the customer status information and the checkout work region information, determining whether to make notification of an assistance request for checkout work; and

making notification of the assistance request through an output apparatus when notification of the assistance request is determined to be made.

Further, the present invention provides a program causing a computer to function as: a customer status information generation unit that, based on an image in which an inside of a store is captured, generates customer status information indicating at least one of a number of one or more customers waiting for checkout and a number of one or more customers in a store;

a checkout work region information generation unit that, based on an image in which an inside of a store is captured, generates checkout work region information indicating status of a checkout work region where a clerk performing checkout work is positioned;

a determination unit that, based on the customer status information and the checkout work region information, determines whether to make notification of an assistance request for checkout work; and

a notification unit that makes notification of the assistance request through an output apparatus when notification of the assistance request is determined to be made.

### Advantageous Effects of Invention

The present invention enables detection of the necessity of increase in the number of clerks performing checkout work and reduction of unnecessary notifications.

### BRIEF DESCRIPTION OF THE DRAWINGS

FIG. 1 is a diagram illustrating an example of a hardware configuration of a notification system according to the present example embodiment.

FIG. 2 is an example of a functional block diagram of the notification system according to the present example embodiment.

FIG. 3 is a diagram for illustrating a concept of a checkout work region and a checkout waiting region according to the present example embodiment.

FIG. 4 is a diagram for illustrating the concept of the checkout work region and the checkout waiting region according to the present example embodiment.

FIG. 5 is a flowchart illustrating an example of a flow of processing of the notification system according to the present example embodiment.

### DESCRIPTION OF EMBODIMENTS

Example embodiments of the present invention will be described below by using drawings. Note that in every drawing, similar components are given similar signs, and description thereof is omitted as appropriate.

### First Example Embodiment

### Overview

A notification system according to the present example embodiment is characterized by determining whether to make notification of an assistance request for checkout work, based on “customer status information” and “checkout work region information,” and making notification in accordance with the determination.

Customer status information indicates at least one of the number of customers waiting for checkout and the number of customers in a store. For example, a region where a customer waiting for checkout is positioned, a store entrance, and the like may be set as a surveillance region, and customer status information may be generated based on an image in which the region is captured. Thus, a region in a store surveilled for generation of customer status information can be a relatively narrow region.

Checkout work region information indicates the status of a checkout work region where a clerk performing checkout work is positioned (such as the inside of a checkout counter). While details will be described later, for example, checkout work region information indicates the number of clerks in a checkout work region and an action contents of the clerks. A checkout work region may be set as a surveillance region, and checkout work region information may be generated based on an image in which the region is captured. Thus, a region in a store surveilled for generation of checkout work region information can be a relatively narrow region.

Determination of whether to make notification of an assistance request for checkout work based on such characteristic customer status information and checkout work region information enables highly precise reduction of unnecessary notifications and reduction of a region to be surveilled in a store compared with that in conventional technologies. Details will be described below.

### Hardware Configuration

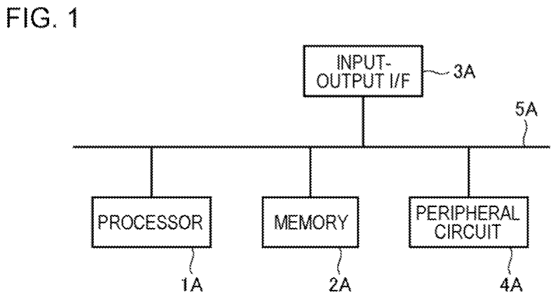

Next, an example of a hardware configuration of the notification system will be described. FIG. 1 is a diagram illustrating a hardware configuration example of the notification system. Each functional unit included in the notification system 10 is provided by any combination of hardware and software centered on a central processing unit (CPU), a memory, a program loaded into the memory, a storage unit, such as a hard disk, storing the program [capable of storing not only a program previously stored in the shipping stage of the apparatus but also a program downloaded from a storage medium such as a compact disc (CD) or a server on the Internet], and a network connection interface in any computer. Then, it may be understood by a person skilled in the art that various modifications to the providing method and the apparatus can be made.

As illustrated in FIG. 1, the notification system includes a processor 1A, a memory 2A, an input-output interface 3A, a peripheral circuit 4A, and a bus 5A. The notification system may not include the peripheral circuit 4A.

Note that the notification system may be configured with a plurality of physically and/or logically separate apparatuses or may be configured with one physically and/or logically integrated apparatus. In the former case, each apparatus may include the aforementioned hardware configuration.

The bus 5A is a data transmission channel for the processor 1A, the memory 2A, the peripheral circuit 4A, and the input-output interface 3A to transmit and receive data to and from one another. Examples of the processor 1A include arithmetic processing units such as a CPU and a graphics processing unit (GPU). Examples of the memory 2A include memories such as a random-access memory (RAM) and a read-only memory (ROM). The input-output interface 3A includes an interface for acquiring information from an input apparatus, an external apparatus, an external server, an external sensor, and the like, and an interface for outputting information to an output apparatus, the external apparatus, the external server, and the like. Examples of the input apparatus include a keyboard, a mouse, and a microphone. Examples of the output apparatus include a display, a speaker, a printer, and a mailer. The processor 1A issues an instruction to each module and can perform an operation, based on the operation result by the module.

### Functional Configuration

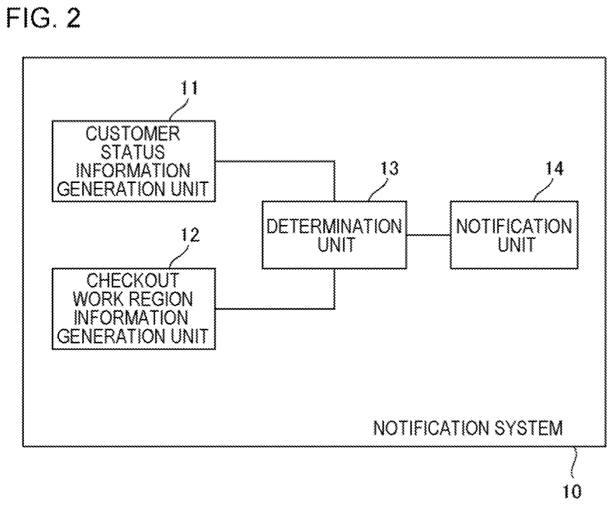

Next, an example of a functional configuration of the notification system 10 will be described. As illustrated in a functional block diagram in FIG. 2, the notification system 10 includes a customer status information generation unit 11, a checkout work region information generation unit 12, a determination unit 13, and a notification unit 14.

Prior to description of the functional units, a “checkout work region” and a “checkout waiting region” will be described. A checkout work region is a partial region in a store and is a region surveilled with a camera for generation of checkout work region information. A checkout waiting region is a partial region in a store and is an example of a region surveilled with a camera for generation of customer status information. A user of the notification system or a servicer providing a service using the notification system 10 may set the regions in consideration of a layout and/or a business practice of each store.

A checkout work region is a region where a clerk performing checkout work is positioned. A clerk performing checkout work is positioned near a checkout apparatus [such as a point of sales (POS) register] and operates the checkout apparatus. A checkout work region is set in such a way as to include a region near the checkout apparatus.

Note that a clerk performing checkout work may perform work other than operation of a checkout apparatus depending on the business category of a store. For example, a clerk operates equipment (such as a microwave oven, a coffee maker, or a ticketing machine) installed near a checkout apparatus and/or takes out a product (such as cigarettes, a delicatessen, a stamp, or a postcard) from a product display area installed near the checkout apparatus. A checkout work region may be set in such a way as to include a region where a clerk is positioned when performing work other than operation of the checkout apparatus.

As described above, a checkout work region is a region surveilled with a camera. A checkout work region is preferably set small in consideration of a burden of costs for introduction and maintenance of equipment, a burden of processing required for image processing by a computer, and the like. However, a checkout work region is preferably set with a certain degree of margin in order to allow a clerk performing checkout work to move freely to a certain degree.

A checkout waiting region is a region where a customer waiting for checkout is positioned. A checkout waiting region is generally positioned near a checkout work region. For example, each store examines a preferable direction in which a line of customers waiting for checkout extends, based on a layout and the like in the store. Then, for example, a notice indicating where to wait at checkout is displayed in the store (such as a floor in the store). Customers waiting for checkout generates a line extending in a predetermined direction in accordance with the notice. For example, a checkout waiting region can be set based on such a business practice at each store.

As described above, a checkout waiting region is an example of a region surveilled with a camera. A checkout waiting region is preferably set small in consideration of a burden of costs for introduction and maintenance of equipment, a burden of processing required for image processing by a computer, and the like. However, a checkout waiting region is preferably set with a certain degree of margin in order to allow a customer waiting for checkout to move freely to a certain degree.

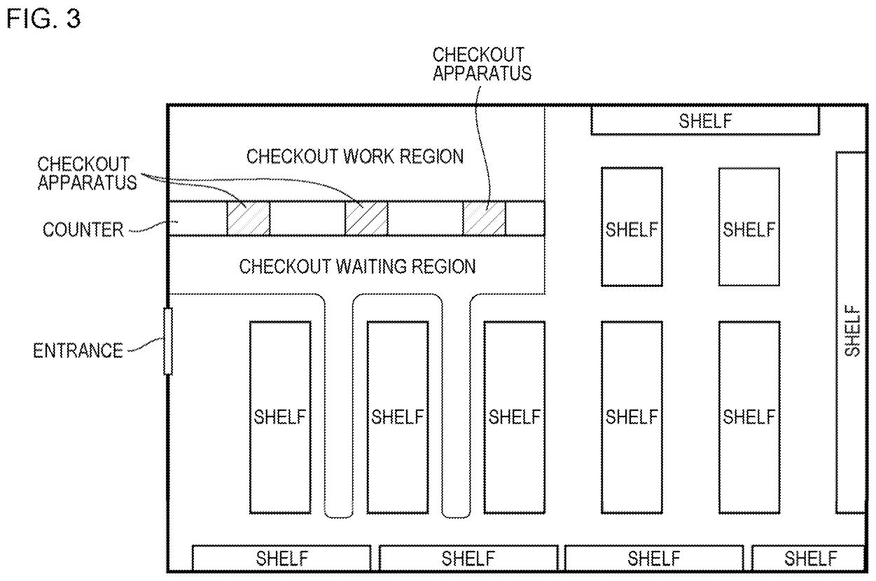

FIG. 3 illustrates an example of a checkout work region and a checkout waiting region. FIG. 3 illustrates a layout in a store. In the example in FIG. 3, a plurality of checkout apparatuses are installed on a counter. Then, the inside of the counter is set as a checkout work region. A clerk operates a checkout apparatus in the checkout work region. Note that a clerk may perform work other than operation of a checkout apparatus in the checkout work region depending on the business category of a store. For example, a clerk operates predetermined equipment (such as a microwave oven, a coffee maker, or a ticketing machine) and/or takes out a product (such as cigarettes, a delicatessen, a stamp, or a postcard) from a predetermined product display area.

Then, in the example in FIG. 3, a checkout waiting region is set in such a way as to include the front of the counter and extend between shelves therefrom.

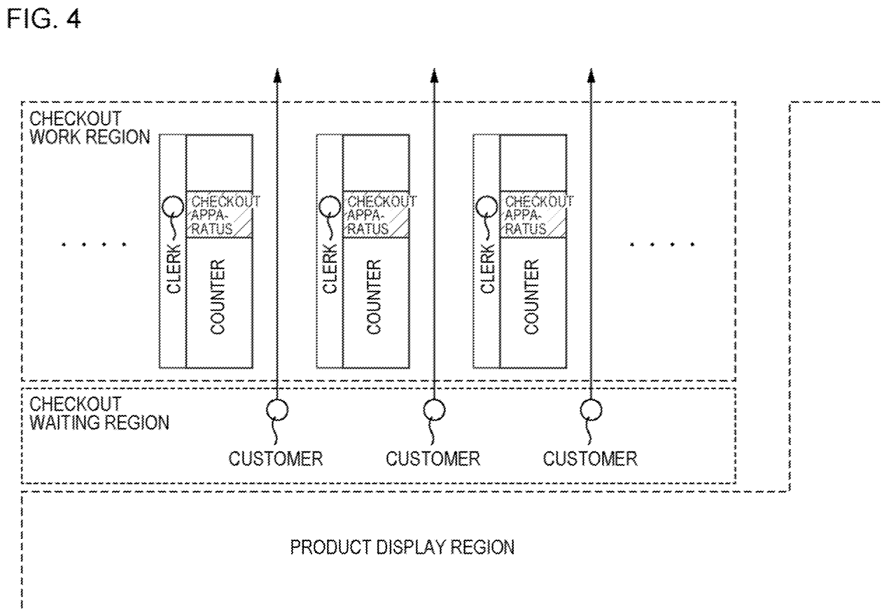

FIG. 4 illustrates another example of a checkout work region and a checkout waiting region. FIG. 4 illustrates a layout in a store. In the example in FIG. 4, a plurality of counters are provided, and a checkout apparatus is installed on each counter. Then, at least one clerk is positioned inside each counter, and customers successively pass on the opposite side of the counter. In the illustrated example, a checkout work region is set in such a way as to include the plurality of counters. Then, a checkout waiting region is set adjacent to the checkout work region.

For example, at least one camera is installed in such a way that the position and the direction of the camera allows image capture of a checkout work region set as illustrated in FIG. 3 or FIG. 4, according to the present example embodiment. Note that, for example, at least one camera may be further installed in such a way that the position and the direction of the camera allows image capture of the checkout work region set as illustrated in FIG. 3 or FIG. 4, according to the present example embodiment.

Returning to FIG. 2, the customer status information generation unit 11 generates customer status information indicating at least one of the number of customers waiting for checkout and the number of customers in a store, based on an image in which the inside of the store is captured. The customer status information generation unit 11 acquires and processes an image generated by a camera installed in the store by real-time processing and generates customer status information.

The number of customers waiting for checkout can be provided by executing image analysis such as human detection on an image in which a checkout waiting region is captured. For example, the number of persons detected in the checkout waiting region may be computed as the number of customers waiting for checkout. In addition, a line of persons may be detected in the checkout waiting region. Then, the number of lined-up persons may be computed as the number of customers waiting for checkout.

The number of customers in the store can be provided by executing image analysis such as human detection or movement trajectory detection on an image in which, for example, a store entrance or a predetermined location connected to the store entrance (such as an aisle) is captured. For example, the number of customers in the store can be detected by incrementing the number of customers in the store by one according to detection of a person coming into the store and decrementing the number of customers in the store by one according to detection of a person going out of the store.

Based on an image in which the checkout work region is captured, the checkout work region information generation unit 12 generates checkout work region information indicating the status of the checkout work region in the store where a clerk performing checkout work is positioned. The checkout work region information generation unit 12 acquires and processes an image generated by a camera installed in the store by real-time processing and generates checkout work region information.

The checkout work region information generation unit 12 can generate checkout work region information indicating at least one of the number of clerks existing in the checkout work region, an action content of each clerk, the position of each clerk in the checkout work region, the direction of the face of each clerk, and the line of sight of each clerk.

Examples of an action content include “operating a checkout apparatus,” “operating a microwave oven,” “operating a coffee maker,” “operating a ticketing machine,” “operating equipment A (any other piece of equipment),” “taking out cigarettes from a cigarette display area,” “taking out a delicatessen from a delicatessen display area,” “taking out a stamp and/or a postcard from a stamp and postcard display area,” and “performing work for a home delivery service (such as measuring a weight and/or dimensions and preparing a slip) but are not limited thereto. The checkout work region information generation unit 12 can estimate an action content of a clerk as described above in accordance with a predetermined algorithm based on a positional relation and a contact state between a clerk and another target object (such as equipment, a display area, an appliance used in work for a home delivery service), a relation between the direction of the face of a clerk and the position of another target object, a relation between the direction of the line of sight of a clerk and the position of another target object, and the like.

Further, based on an image in which the inside of the store is captured, the checkout work region information generation unit 12 can generate checkout work region information indicating the operating status of equipment installed in the checkout work region. Target equipment of the processing includes at least one of a checkout apparatus and a piece of equipment other than the checkout apparatus (such as a microwave oven, a coffee maker, or a ticketing machine).

Operating status indicates whether equipment is in operation. When the appearance of equipment differs between an in-operation state and an out-of-operation state, the checkout work region information generation unit 12 may determine whether each piece of equipment is in operation by detecting the difference in the appearance by image analysis. In addition, the checkout work region information generation unit 12 may detect the status of a region around equipment by image analysis and determine whether each piece of equipment is in operation, based on the detection result. For example, when a clerk touching equipment is detected, the equipment may be determined to be in operation. Further, when a clerk staying in front of equipment for a predetermined time or longer is detected, the equipment may be determined to be in operation. Further, when a clerk having the direction of the face being continuously directed toward equipment for a predetermined time or longer is detected, the equipment may be determined to be in operation. Further, when a clerk having the direction of the line of sight being continuously directed toward equipment is detected, the equipment may be determined to be in operation. Note that the exemplifications described above are strictly examples, and operating status is not limited thereto.

In addition, the checkout work region information generation unit 12 may generate checkout work region information indicating the operating status of equipment installed in the checkout work region, based on information acquired from an external apparatus. For example, equipment itself may output information indicating whether the equipment is in operation. Then, the checkout work region information generation unit 12 may acquire the information by real-time processing directly from the equipment or through another apparatus such as a store server.

Based on customer status information and checkout work region information, the determination unit 13 determines whether to make notification of an assistance request for checkout work.

The determination unit 13 determines to make notification of an assistance request when at least one of “the number of customers waiting for checkout is equal to or greater than a first reference value,” “the number of customers in the store is equal to or greater than a second reference value,” and “the number of customers waiting for checkout is equal to or greater than a third reference value and the number of customers in the store is equal to or greater than a fourth reference value” is satisfied and the status of the checkout work region indicated by checkout work region information satisfies a predetermined condition.

Congestion at checkout at the present time can be detected by determination on the aforementioned condition related to the number of customers waiting for checkout. Further, the possibility of congestion at checkout in the relatively near future can be detected by determination on the aforementioned condition related to the number of customers in the store. Then, while details will be described below, the necessity of notification of an assistance request can be determined based on necessity, validity, and the like, by determination on the aforementioned condition related to the status of the checkout work region.

Note that the first reference value and the third reference value described above may have the same value or different values. Further, the second reference value and the fourth reference value described above may have the same value or different values.

A predetermined condition related to the status of the checkout work region (hereinafter referred to as a “checkout work region condition”) and the meaning thereof will be described.

For example, the checkout work region condition is one condition out of “the number of clerks existing in the checkout work region is equal to or less than a fifth reference value,”
“the number of clerks existing in the checkout work region and performing a predetermined action is equal to or less than a sixth reference value,”
“the number of clerks existing in the checkout work region and being at a predetermined position in the checkout work region is equal to or less than a seventh reference value,”
“the number of clerks existing in the checkout work region and having the face directed in a predetermined direction is equal to or less than an eighth reference value,”
“the number of clerks existing in the checkout work region and having a predetermined line-of-sight state is equal to or less than a ninth reference value,”
“a clerk existing in the checkout work region and performing a predetermined action other than checkout work exists,”
“a clerk existing in the checkout work region and being at a position different from a position where the clerk stays during checkout work exists,”
“a clerk existing in the checkout work region and having a direction of the face in a state different from a state during checkout work exists,”
“a clerk existing in the checkout work region and having a line-of-sight state different from a state during checkout work exists,”
“the number of checkout apparatuses in operation is equal to or less than a tenth reference value,”
“predetermined equipment other than a checkout apparatus is in operation,” and
“the number of clerks existing in the checkout work region is less than the number of clerks at work then,”
or a condition acquired by connecting more than one of the above conditions by one or more logical operators. Each condition will be described below.
   Number of Clerks Existing in Checkout Work Region Is Equal to or Less than Fifth Reference Value

When the number of clerks existing in the checkout work region is small in congested status of checkout or possible congested status of checkout in the relatively near future, the number of clerks needs to be increased by notification of an assistance request. Increase in the number of clerks enables improvement in checkout work efficiency and reduction in customer waiting time. On the other hand, when a sufficient number of clerks already exist in the checkout work region, improvement in checkout work efficiency cannot be expected by further increasing the number of clerks. Rather, the number of clerks in the checkout work region may become excessive, which may cause a harmful effect such as degradation in work efficiency. The condition enables determination of notification of an assistance request at a necessary and effective timing by suitably setting the fifth reference value.

Number of Clerks Existing in Checkout Work Region and Performing Predetermined Action Is Equal to or Less than Sixth Reference Value

The predetermined action is operation of a checkout apparatus. When the number of clerks operating the checkout apparatuses is small in congested status of checkout or possible congested status of checkout in the relatively near future, the number of clerks needs to be increased by notification of an assistance request. Increase in the number of clerks enables improvement in checkout work efficiency and reduction in customer waiting time. On the other hand, when a sufficient number of clerks are already operating the checkout apparatuses, improvement in checkout work efficiency cannot be expected by further increasing the number of clerks. Rather, the number of clerks in the checkout work region may become excessive, which may cause a harmful effect such as degradation in work efficiency. The condition enables determination of notification of an assistance request at a necessary and effective timing by suitably setting the sixth reference value.

Number of Clerks Existing in Checkout Work Region and Being at Predetermined Position in Checkout Work Region Is Equal to or Less than Seventh Reference Value

The predetermined position is a position where a clerk stays when operating a checkout apparatus, such as the front of the checkout apparatus. When the number of clerks staying at the aforementioned predetermined position is small, that is, when the number of clerks operating the checkout apparatuses is small in congested status of checkout or possible congested status of checkout in the relatively near future, the number of clerks needs to be increased by notification of an assistance request. Increase in the number of clerks enables improvement in checkout work efficiency and reduction in customer waiting time. On the other hand, when a sufficient number of clerks are already operating the checkout apparatuses, improvement in checkout work efficiency cannot be expected by further increasing the number of clerks. Rather, the number of clerks in the checkout work region may become excessive, which may cause a harmful effect such as degradation in work efficiency. The condition enables determination of notification of an assistance request at a necessary and effective timing by suitably setting the seventh reference value.

Number of Clerks Existing in Checkout Work Region and Having Face Directed in Predetermined Direction Is Equal to or Less than Eighth Reference Value

The face being directed in a predetermined direction is a state that may occur when a checkout apparatus is operated. Examples of such a state include a state of facing the checkout apparatus, a state of facing a customer in front of the checkout apparatus, and a state of facing a region of a counter on which a checkout target product is placed. When the number of clerks having the face directed in the aforementioned predetermined direction is small, that is, when the number of clerks operating the checkout apparatuses is small in congested status of checkout or possible congested status of checkout in the relatively near future, the number of clerks needs to be increased by notification of an assistance request. Increase in the number of clerks enables improvement in checkout work efficiency and reduction in customer waiting time. On the other hand, when a sufficient number of clerks are already operating the checkout apparatuses, improvement in checkout work efficiency cannot be expected by further increasing the number of clerks. Rather, the number of clerks in the checkout work region may become excessive, which may cause a harmful effect such as degradation in work efficiency. The condition enables determination of notification of an assistance request at a necessary and effective timing by suitably setting the eighth reference value.

Number of Clerks Existing in Checkout Work Region and Having Predetermined Line-of-sight State Is Equal to or Less than Ninth Reference Value

The predetermined line of sight state is a state that may occur when a checkout apparatus is operated. Examples of such a state include a state of facing the checkout apparatus, a state of facing a customer in front of the checkout apparatus, and a state of facing a region of a counter on which a checkout target product is placed. When the number of clerks in the aforementioned line of sight state is small, that is, when the number of clerks operating the checkout apparatuses is small in congested status of checkout or possible congested status of checkout in the relatively near future, the number of clerks needs to be increased by notification of an assistance request. Increase in the number of clerks enables improvement in checkout work efficiency and reduction in customer waiting time. On the other hand, when a sufficient number of clerks are already operating the checkout apparatuses, improvement in checkout work efficiency cannot be expected by further increasing the number of clerks. Rather, the number of clerks in the checkout work region may become excessive, which may cause a harmful effect such as degradation in work efficiency. The condition enables determination of notification of an assistance request at a necessary and effective timing by suitably setting the ninth reference value.

Clerk Existing in Checkout Work Region and Performing Predetermined Action Other than Checkout Work Exists

Examples of the predetermined action include “operating a microwave oven,” “operating a coffee maker,” “operating a ticketing machine,” “operating equipment A (any other piece of equipment),” “taking out cigarettes from a cigarette display area,” “taking out a delicatessen from a delicatessen display area,” “taking out a stamp and/or a postcard from a stamp and postcard display area,” and “performing work for a home delivery service (such as measuring a weight and/or dimensions and preparing a slip). Note that the predetermined action may be work that may bind a clerk in the checkout work region for a relatively long time out of such actions that may be performed by the clerk. Examples of such an action include “operating a coffee maker,” “operating a ticketing machine,” “taking out a stamp and/or a postcard from a stamp and postcard display area,” and “performing work for a home delivery service (such as measuring a weight and/or dimensions and preparing a slip) but are not limited thereto.

When a clerk performing such a predetermined action exists, that is, when a clerk in status of not being able to immediately operate a checkout apparatus exists in congested status of checkout or possible congested status of checkout in the relatively near future, the number of clerks needs to be increased by notification of an assistance request. The condition enables determination of notification of an assistance request at a necessary and effective timing.

Clerk Existing in Checkout Work Region and Being at Position Different from Position Where Clerk Stays During Checkout Work Exists

When a clerk existing at a position different from a position where the clerk stays during checkout work and performing work other than operation of the checkout apparatus exists in congested status of checkout or possible congested status of checkout in the relatively near future, the number of clerks needs to be increased by notification of an assistance request. The condition enables determination of notification of an assistance request at a necessary and effective timing.

Clerk Existing in Checkout Work Region and Having Direction of Face in State Different from State During Checkout Work Exists

When a clerk having a direction of the face in a state different from a state during checkout work exists, that is, when a clerk performing work other than operation of a checkout apparatus exists in congested status of checkout or possible congested status of checkout in the relatively near future, the number of clerks needs to be increased by notification of an assistance request. The condition enables determination of notification of an assistance request at a necessary and effective timing.

Clerk Existing in Checkout Work Region and Having Line-of-sight State Different from State During Checkout Work Exists

When a clerk having a line of sight in a state different from a state during checkout work exists, that is, when a clerk performing work other than operation of a checkout apparatus exists in congested status of checkout or possible congested status of checkout in the relatively near future, the number of clerks needs to be increased by notification of an assistance request. The condition enables determination of notification of an assistance request at a necessary and effective timing.

Number of Checkout Apparatuses in Operation Is Equal to or Less than Tenth Reference Value

When the number of checkout apparatuses in operation is equal to or less than the tenth reference value (the tenth reference value is less than the number of existing checkout apparatuses) and a checkout apparatus not yet being in operation exists in congested status of checkout or possible congested status of checkout in the relatively near future, the number of checkout apparatuses in operation needs to be increased by notification of an assistance request. The condition enables determination of notification of an assistance request at a necessary and effective timing.

Predetermined Equipment Other than Checkout Apparatus Is in Operation

The predetermined equipment is installed in the checkout work region and is a target to be operated by a clerk, examples of such equipment including a microwave oven, a coffee maker, and a ticketing machine. Note that the predetermined equipment may be equipment binding a clerk to work therefor for a relatively long time out of such pieces of equipment. Examples of such equipment include a coffee maker and a ticketing machine but are not limited thereto.

When a clerk operating the predetermined equipment exists, that is, a clerk performing work other than operation of a checkout apparatus exists in congested status of checkout or possible congested status of checkout in the relatively near future, the number of clerks needs to be increased by notification of an assistance request. The condition enables determination of notification of an assistance request at a necessary and effective timing.

Number of Clerks Existing in Checkout Work Region Is Less than Number of Clerks at Work Then

The number of clerks existing in the checkout work region being less than the number of clerks at work then means that a clerk not existing in the checkout work region exists. In this case, increase in the number of clerks in the checkout work region is provided by notification of an assistance request. On the other hand, the number of clerks existing in the checkout work region being equal to the number of clerks at work then means that every clerk at work exists in the checkout work region. In this case, the number of clerks in the checkout work region is not increased even when notification of an assistance request is made. The condition enables determination of notification of an assistance request at a necessary and effective timing.

The determination unit 13 detects whether the condition is satisfied by detecting the number of clerks at work and comparing the number with the number of clerks existing in the checkout work region. The number of clerks at work may be detected based on a previously prepared work shift table, may be detected based on information managed by an attendance status management apparatus managing attendance status of clerks, or may be detected by another means.

When notification of an assistance request for checkout work is determined to be made by the determination unit 13, the notification unit 14 makes notification of an assistance request through an output apparatus. Examples of the output apparatus include a display, a speaker, and a mobile terminal but are not limited thereto.

For example, notification of an assistance request may be made to every clerk existing in the store through one or a plurality of speakers installed in such a way as to deliver sound to the entire region in the store. In addition, notification of an assistance request may be made to a clerk existing in a predetermined partial region in the store through a speaker, a display, or the like installed in a predetermined partial region such as a backyard of the store. In addition, notification of an assistance request may be made to a predetermined clerk through a mobile terminal held by the predetermined clerk. An electronic mail, push notification by an application, or the like may be used in notification through a mobile terminal. The predetermined clerk may be a manager such as a store manager or a leader. In addition, the predetermined clerk may be a clerk not existing in the checkout work region.

For example, determination of a clerk not existing in the checkout work region may be provided by processing as follows. First, clerks existing in the checkout work region are determined by face authentication processing based on an image generated by a camera capturing an image of the checkout work region. Further, clerks at work then are determined based on the previously prepared work shift table or information managed by the attendance status management apparatus managing attendance status of clerks. Then, a clerk remaining after subtracting the clerks existing in the checkout work region from the clerks at work is determined as a clerk not existing in the checkout work region.

Note that the notification unit 14 may make notification of a content other than an assistance request. For example, when equipment other than a checkout apparatus (such as a microwave oven, a coffee maker, or a ticketing machine) is detected to be in operation or when a clerk performing work other than checkout work in the checkout work region is detected, notification of a request for helping operation of the equipment or helping the work may be made. In this case, notification of information for identifying the equipment or information for identifying the work may be made.

Further, when detecting an event that notification of an assistance request is not made due to the number of clerks existing in the checkout work region being equal to the number of clerks at work then or when detecting the event a predetermined times or more in a predetermined period, the notification unit 14 may make notification of a request for an improved shift. The notification is made to a predetermined person (such as a store manager). A means for providing the notification is not particularly limited.

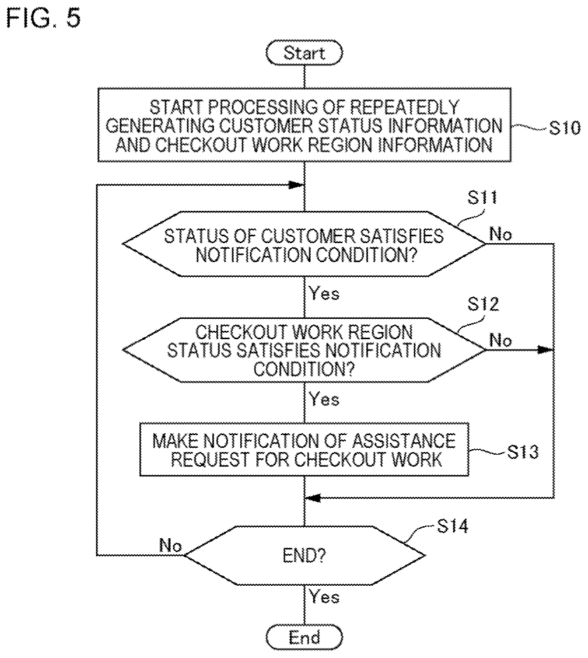

Next, an example of a flow of processing in the notification system 10 will be described by using a flowchart in FIG. 5.

First, generation of customer status information by the customer status information generation unit 11 and generation of checkout work region information by the checkout work region information generation unit 12 are started (S10). The customer status information generation unit 11 and the checkout work region information generation unit 12 repeatedly generate the pieces of information until the processing ends.

The determination unit 13 determines whether the status of a customer satisfies a notification condition for an assistance request, based on the customer status information (S11). When the condition is satisfied (Yes in S11), the determination unit 13 determines whether the status of the checkout work region satisfies the notification condition for an assistance request, based on the checkout work region information (S12). When the condition is satisfied (Yes in S12), the notification unit 14 makes notification of an assistance request (S13).

When the status of the customer does not satisfy the notification condition for an assistance request (No in S11) or the status of the checkout work region does not satisfy the notification condition for an assistance request (No in S12), the notification unit 14 does not make notification of an assistance request.

### Advantageous Effects

The notification system 10 according to the present example embodiment determines whether to make notification of an assistance request for checkout work, based on “customer status information” and “checkout work region information.” By using the customer status information, congestion at checkout at the present time and the possibility of congestion at checkout in the relatively near future can be detected. Then, by using the checkout work region information, the necessity and the validity of an assistance request can be suitably determined based on the status of a checkout work region. Such a notification system 10 determining, based on customer status information and checkout work region information, whether to make notification of an assistance request for checkout work enables effective reduction of unnecessary notifications.

Further, generation of customer status information can be provided by surveilling the aforementioned checkout waiting region, or an entrance of a store or the like. Then, generation of checkout work region information can be provided by surveilling the aforementioned checkout work region. Since only such a relatively narrow region needs to be surveilled, a burden of costs for introduction and maintenance of equipment, a burden of processing required for image processing by a computer, and the like can be reduced.

Further, the necessity and the validity of an assistance request is determined based on a characteristic checkout work region condition as described above, and therefore, the necessity and the validity of an assistance request can be determined with high precision.

While the example embodiments of the present invention have been described above with reference to the drawings, the example embodiments are exemplifications of the present invention, and various configurations other than those described above may be employed.

Note that “acquisition” herein includes at least one item out of “an apparatus getting data stored in another apparatus or a storage medium (active acquisition)” such as making a request or an inquiry to another apparatus and receiving a response and readout by accessing another apparatus or a storage medium, in accordance with a user input or a program instruction, or “an apparatus inputting data output from another apparatus to the apparatus (passive acquisition)” such as reception of distributed (or, for example, transmitted or push notified) data and acquisition by selection from received data or information, in accordance with a user input or a program instruction, and “generating new data by data editing (such as conversion to text, data rearrangement, partial data extraction, or file format change) and acquiring the new data.”

The whole or part of the example embodiments disclosed above may also be described as, but not limited to, the following supplementary notes.
1. A notification system including:
   a customer status information generation unit that, based on an image in which an inside of a store is captured, generates customer status information indicating at least one of a number of one or more customers waiting for checkout and a number of one or more customers in a store;
   a checkout work region information generation unit that, based on an image in which an inside of a store is captured, generates checkout work region information indicating status of a checkout work region where a clerk performing checkout work is positioned;
   a determination unit that, based on the customer status information and the checkout work region information, determines whether to make notification of an assistance request for checkout work; and
   a notification unit that makes notification of the assistance request through an output apparatus when notification of the assistance request is determined to be made.
2. The notification system according to 1, wherein
   the determination unit determines to make notification of the assistance request when at least one of
   “a number of one or more customers waiting for checkout is equal to or greater than a first reference value,”
   “a number of one or more customers in a store is equal to or greater than a second reference value,” and
   “a number of one or more customers waiting for checkout is equal to or greater than a third reference value and a number of one or more customers in a store is equal to or greater than a fourth reference value” is satisfied and
   status of the checkout work region indicated by the checkout work region information satisfies a predetermined condition.
3. The notification system according to 1 or 2, wherein
   the checkout work region information generation unit generates the checkout work region information indicating at least one of a number, an action content, a position, a direction of a face, and a line of sight of one or more clerks existing in the checkout work region.
4. The notification system according to 3, wherein
   the determination unit determines to make notification of the assistance request when status of the checkout work region indicated by the checkout work region information satisfies a predetermined condition, and
   the predetermined condition is one condition out of
   “a number of one or more clerks existing in the checkout work region is equal to or less than a fifth reference value,”
   “a number of one or more clerks existing in the checkout work region and performing a predetermined action is equal to or less than a sixth reference value,”
   “a number of one or more clerks existing in the checkout work region and being at a predetermined position in the checkout work region is equal to or less than a seventh reference value,”
   “a number of one or more clerks existing in the checkout work region and having a face directed in a predetermined direction is equal to or less than an eighth reference value,”
   “a number of one or more clerks existing in the checkout work region and having a predetermined line-of-sight state is equal to or less than a ninth reference value,”
   “a clerk existing in the checkout work region and performing a predetermined action other than checkout work exists,”
   “a clerk existing in the checkout work region and being at a position different from a position where the clerk stays during checkout work exists,”
   “a clerk existing in the checkout work region and having a direction of a face in a state different from a state during checkout work exists,” and
   “a clerk existing in the checkout work region and having a line-of-sight state different from a state during checkout work exists” or a condition acquired by connecting more than one of the above conditions by a logical operator.
5. The notification system according to any one of 1 to 4, wherein
   the checkout work region information generation unit generates the checkout work region information indicating operating status of equipment installed in the checkout work region, based on an image in which an inside of a store is captured or based on information acquired from an external apparatus, and
   the equipment includes at least one of a checkout apparatus and a piece of equipment other than a checkout apparatus.
6. The notification system according to 5, wherein
   the determination unit determines to make notification of the assistance request when status of the checkout work region indicated by the checkout work region information satisfies a predetermined condition, and
   the predetermined condition is one condition out of
   “a number of one or more checkout apparatuses in operation is equal to or less than a tenth reference value” and
   “predetermined equipment other than a checkout apparatus is in operation” or a condition acquired by connecting more than one of the above conditions by a logical operator.
7. The notification system according to any one of 1 to 6, wherein
   the determination unit
      detects a number of one or more clerks at work and
      determines to make notification of the assistance request when status of the checkout work region indicated by the checkout work region information satisfies a predetermined condition, and
   the predetermined condition is “a number of one or more clerks existing in the checkout work region is less than a number of one or more clerks at work then.”
8. The notification system according to 7, wherein the determination unit detects a number of one or more clerks at work, based on shift information or information managed by an attendance status management apparatus.
9. A notification method including, by a computer:
   based on an image in which an inside of a store is captured, generating customer status information indicating at least one of a number of one or more customers waiting for checkout and a number of one or more customers in a store;
   based on an image in which an inside of a store is captured, generating checkout work region information indicating status of a checkout work region where a clerk performing checkout work is positioned;
   based on the customer status information and the checkout work region information, determining whether to make notification of an assistance request for checkout work; and
   making notification of the assistance request through an output apparatus when notification of the assistance request is determined to be made.
10. A program causing a computer to function as:
   a customer status information generation unit that, based on an image in which an inside of a store is captured, generates customer status information indicating at least one of a number of one or more customers waiting for checkout and a number of one or more customers in a store;
   a checkout work region information generation unit that, based on an image in which an inside of a store is captured, generates checkout work region information indicating status of a checkout work region where a clerk performing checkout work is positioned;
   a determination unit that, based on the customer status information and the checkout work region information, determines whether to make notification of an assistance request for checkout work; and
   a notification unit that makes notification of the assistance request through an output apparatus when notification of the assistance request is determined to be made.

This application claims priority based on Japanese Patent Application No. 2020-196691 filed on Nov. 27, 2020, the disclosure of which is hereby incorporated by reference thereto in its entirety.

### REFERENCE SIGNS LIST

10 Notification system
11 Customer status information generation unit
12 Checkout work region information generation unit
13 Determination unit
14 Notification unit
1A Processor
2A Memory
3A Input-output OF
4A Peripheral circuit
5A Bus

What is claimed is:

1. A notification system comprising:
at least one memory configured to store one or more instructions; and
at least one processor configured to execute the one or more instructions to:
generate, based on an image in which an inside of a store is captured, customer status information indicating at least one of a number of one or more customers waiting for checkout and a number of one or more customers in a store;
generate, based on an image in which an inside of a store is captured, checkout work region information indicating status of a checkout work region where a clerk performing checkout work is positioned;
determine, based on the customer status information and the checkout work region information, whether to make notification of an assistance request for checkout work; and
make notification of the assistance request through an output apparatus when notification of the assistance request is determined to be made.

2. The notification system according to claim 1, wherein
the processor is further configured to execute the one or more instructions to determine to make notification of the assistance request when at least one of
“a number of one or more customers waiting for checkout is equal to or greater than a first reference value,”
“a number of one or more customers in a store is equal to or greater than a second reference value,” and
“a number of one or more customers waiting for checkout is equal to or greater than a third reference value and a number of one or more customers in a store is equal to or greater than a fourth reference value” is satisfied and
status of the checkout work region indicated by the checkout work region information satisfies a predetermined condition.

3. The notification system according to claim 1 wherein the processor is further configured to execute the one or more instructions to generate the checkout work region information indicating at least one of a number, an action content, a position, a direction of a face, and a line of sight of one or more clerks existing in the checkout work region.

4. The notification system according to claim 3, wherein
the processor is further configured to execute the one or more instructions to determine to make notification of the assistance request when status of the checkout work region indicated by the checkout work region information satisfies a predetermined condition, and
the predetermined condition is one condition out of
“a number of one or more clerks existing in the checkout work region is equal to or less than a fifth reference value,”
“a number of one or more clerks existing in the checkout work region and performing a predetermined action is equal to or less than a sixth reference value,”
“a number of one or more clerks existing in the checkout work region and being at a predetermined position in the checkout work region is equal to or less than a seventh reference value,”
“a number of one or more clerks existing in the checkout work region and having a face directed in a predetermined direction is equal to or less than an eighth reference value,”
“a number of one or more clerks existing in the checkout work region and having a predetermined line-of-sight state is equal to or less than a ninth reference value,”
“a clerk existing in the checkout work region and performing a predetermined action other than checkout work exists,”
“a clerk existing in the checkout work region and being at a position different from a position where the clerk stays during checkout work exists,”
“a clerk existing in the checkout work region and having a direction of a face in a state different from a state during checkout work exists,” and
“a clerk existing in the checkout work region and having a line-of-sight state different from a state during checkout work exists” or a condition acquired by connecting more than one of the above conditions by a logical operator.

5. The notification system according to claim 1 wherein the processor is further configured to execute the one or more instructions to generate the checkout work region information indicating operating status of equipment installed in the checkout work region, based on an image in which an inside of a store is captured or based on information acquired from an external apparatus, and
the equipment includes at least one of a checkout apparatus and a piece of equipment other than a checkout apparatus.

6. The notification system according to claim 5, wherein
the processor is further configured to execute the one or more instructions to determine to make notification of the assistance request when status of the checkout work region indicated by the checkout work region information satisfies a predetermined condition, and
the predetermined condition is one condition out of
“a number of one or more checkout apparatuses in operation is equal to or less than a tenth reference value” and
“predetermined equipment other than a checkout apparatus is in operation” or a condition acquired by connecting more than one of the above conditions by a logical operator.

7. The notification system according to claim 1 wherein
the processor is further configured to execute the one or more instructions to
detect a number of one or more clerks at work and
determine to make notification of the assistance request when status of the checkout work region indicated by the checkout work region information satisfies a predetermined condition, and
the predetermined condition is “a number of one or more clerks existing in the checkout work region is less than a number of one or more clerks at work then.”

8. The notification system according to claim 7, wherein
the processor is further configured to execute the one or more instructions to detect a number of one or more clerks at work, based on shift information or information managed by an attendance status management apparatus.

9. A notification method comprising, by a computer:
based on an image in which an inside of a store is captured, generating customer status information indicating at least one of a number of one or more customers waiting for checkout and a number of one or more customers in a store;
based on an image in which an inside of a store is captured, generating checkout work region information indicating status of a checkout work region where a clerk performing checkout work is positioned;
based on the customer status information and the checkout work region information, determining whether to make notification of an assistance request for checkout work; and
making notification of the assistance request through an output apparatus when notification of the assistance request is determined to be made.

10. A non-transitory storage medium storing a program causing a computer to:
generate, based on an image in which an inside of a store is captured, customer status information indicating at least one of a number of one or more customers waiting for checkout and a number of one or more customers in a store;
generate, based on an image in which an inside of a store is captured, checkout work region information indicating status of a checkout work region where a clerk performing checkout work is positioned;
determine, based on the customer status information and the checkout work region information, whether to make notification of an assistance request for checkout work; and
make notification of the assistance request through an output apparatus when notification of the assistance request is determined to be made.
